(19) United States
(12) Patent Application Publication
(10) Pub. No.: US 2026/0140678 A1
(43) Pub. Date: May 21, 2026

(54) IMAGE FORMING DEVICE MODIFYING TARGET SETTING WHEN STORED INFORMATION INDICATES THAT MODIFICATION IS PERMITTED

(71) Applicant: BROTHER KOGYO KABUSHIKI KAISHA, Nagoya (JP)

(72) Inventor: Satoru ARAKANE, Nagoya (JP)

(73) Assignee: BROTHER KOGYO KABUSHIKI KAISHA, Nagoya (JP)

(21) Appl. No.: 19/351,525

(22) Filed: Oct. 7, 2025

(30) Foreign Application Priority Data
Nov. 20, 2024 (JP) 2024-202162

(51) Int. Cl. G06F 3/12

(52) U.S. Cl. CPC G06F 3/1239; G06F 3/1205; G06F 3/1208; G06F 3/1253

(57) ABSTRACT

A controller of an image forming device performs a printing process including printing one or more images on one or more sheets using the printing engine based on a print instruction. The controller performs a setting modification process in response to receiving, under a modification condition, a modification instruction during the printing process. The modification instruction is to modify a target setting. The modification condition includes a requirement that setting permission information stored in the storage indicates that modification of the target setting is permitted during printing. The setting modification process includes modifying the target setting stored in the storage based on the modification instruction. Even when the controller receives the modification instruction during printing on one sheet, the setting modification process is not performed at least during printing on the one sheet when the setting permission information indicates that modification of the target setting is not permitted during printing.

### SPECIFICATION

### REFERENCE TO RELATED APPLICATIONS

This application claims priority from Japanese Patent Application No. 2024-202162 filed on November 20, 2024. The entire content of the priority application is incorporated herein by reference.

### BACKGROUND ART

It is known a system in which an external device, such as a computer, transmits image data to an image forming device, and the image forming device forms an image represented by this image data on a medium. For example, a printer serving as the image forming device performs printing (image formation) based on image data obtained from a digital camera serving as the external device. In this example, since print settings can be configured on the printer, the printer can print based on image data received from the external device in accordance with the print settings configured on the printer.

### SUMMARY

When settings for image formation (print settings) can be configured on an image forming device, it is conceivable that a user might attempt to modify the values of these setting during an image formation process through operations on the image forming device. However, modifying settings during image formation could generate an undesirable situation. For example, some setting modifications could cause the image quality to change during image formation.

In view of the foregoing, it is an object of the present disclosure to provide an image forming device capable of suitably handling situations in which a user attempts to modify settings during image formation.

In order to attain the above and other objects, the present disclosure provides an image forming device. The image forming device includes a printing engine, a user interface, a storage, and a controller. The controller includes one or more processors. The controller is configured to perform: a printing process including: printing one or more images on one or more sheets using the printing engine based on a print instruction; and a setting modification process in response to receiving, under a modification condition, a modification instruction through the user interface during the printing process, the modification instruction being an instruction to modify a target setting, the target setting being a setting of one or more settings stored in the storage, the modification condition including a requirement that setting permission information stored in the storage indicates that modification of the target setting is permitted during printing, the setting modification process including: modifying the target setting stored in the storage based on the modification instruction. Even when the controller receives the modification instruction through the user interface during printing on one sheet of the one or more sheets, the setting modification process is not performed at least during printing on the one sheet under a disable condition including a requirement that the setting permission information indicates that modification of the target setting is not permitted during printing.

In the above structure, in response to receiving the modification instruction during the printing process, the target setting is changed when the corresponding modification permission information indicates that modification is permitted. On the other hand, the target setting is not changed when the modification permission information indicates that modification is not permitted. This method makes it possible to modify the target setting quickly when possible while reducing the occurrence of undesirable situations such as the quality of an image being changed during the printing process. Accordingly, this method can realize a device capable of responding appropriately to situations in which change is about to occur to the target setting during the printing process.

### BRIEF DESCRIPTION OF DRAWINGS

FIG. 1 is a block diagram illustrating a printing system including a printer.

FIG. 2 is a block diagram illustrating information stored in the printer.

FIG. 3A is an illustration showing a graphical user interface image displayed on a touchscreen display for receiving a value of a unidirectional setting.

FIG. 3B is an illustration showing a graphical user interface image displayed on the touchscreen display of the printer for receiving a value of a smudge reduction setting.

FIG. 4A is an illustration showing a graphical user interface image displayed on a display of a personal computer for receiving a value of the unidirectional setting.

FIG. 4B is an illustration showing a graphical user interface image displayed on the display of the personal computer for receiving a value of the smudge reduction setting.

FIG. 4C is an illustration showing a graphical user interface image displayed on the display of the personal computer for receiving a value of an instant change setting.

FIG. 5 is a flowchart illustrating a process executed by a controller of the printer in response to reception of print job data.

FIG. 6 is a flowchart a process executed by the controller in response to reception of a setting change operation during an image forming process.

### DESCRIPTION

A printing system 1 according to an embodiment of the present disclosure will be described while referring to the accompanying drawings. The printing system 1 has a printer 100 and a PC 200. The printer 100 and PC 200 are connected to each other and capable of exchanging data over a communication network such as the Internet, and a local area network (LAN). The printer 100 is an example of the image forming device.

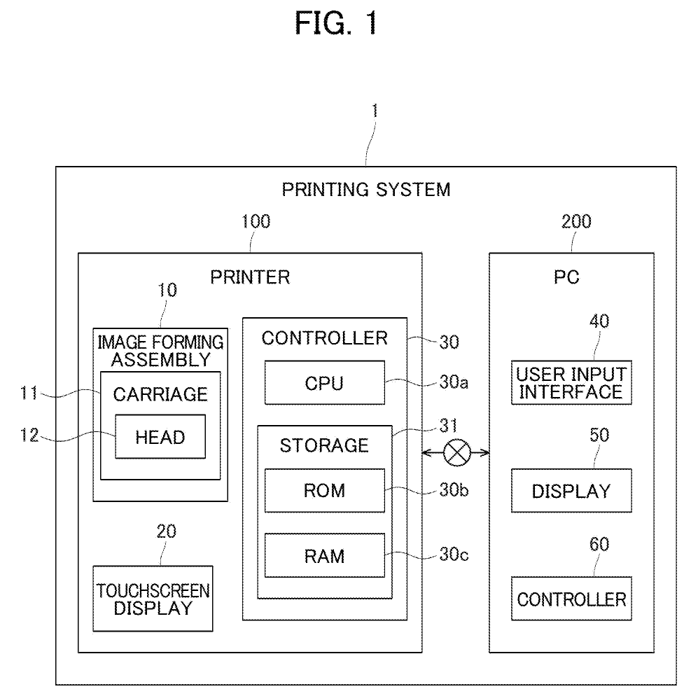

As shown in FIG. 1, the printer 100 has an image forming assembly 10, a touchscreen display 20, and a controller 30. The image forming assembly 10 can accommodate a plurality of sheets of paper.

The image forming assembly 10 has a carriage 11, and a head 12 supported in the carriage 11. The carriage 11 can reciprocate over a sheet of paper along a path from one edge to the other edge of the sheet in the width direction of the same. The image forming assembly 10 performs an image forming operation (a printing operation) to form images on sheets of paper by moving the carriage 11 in the width direction of the sheets while controlling the head 12 supported in the carriage 11 to deposit ink on the sheets. The image forming operation is an example of a moving image formation. The head 12 is an example of the image forming engine or the printing engine.

In this specification, a setting item may simply be referred to as a “setting.” Setting values may be referred to simply as “settings.” The term “variable” refers to a container holding a value, which may be referenced or modified during execution of processing. The term “value”, “setting value”, “content”, or “setting content” refers to specific data assigned to a variable or parameter. The term “parameter” refers to a variable element that receives input or to the value assigned to such an element, depending on the context. A parameter is used as a configurable element that influences processing conditions or behaviors. The term “setting item” refers to a representation, identifier, or name of a variable or parameter.

This embodiment describes two settings related to image forming operations performed by the image forming assembly 10. The first setting is a unidirectional setting. The unidirectional setting switches whether the image forming assembly 10 performs bidirectional forming operations or unidirectional forming operations. In a bidirectional forming operation, the image forming assembly 10 operates in such a manner that the head 12 deposits ink on sheets while the carriage 11 is moving in both forward and backward directions. In a unidirectional forming operation, the image forming assembly 10 operates in such a manner that the head 12 deposits ink on sheets only while the carriage 11 is moving in the outward direction. The unidirectional setting can be selectively set to either ON or OFF. The unidirectional setting of ON corresponds to using the unidirectional forming operation, while the unidirectional setting of OFF corresponds to using the bidirectional forming operation.

The second setting is a smudge reduction setting. The smudge reduction setting switches the operating mode of the image forming assembly 10 between a normal mode and a smudge reduction mode. In the normal mode, the image forming assembly 10 uses the amounts of ink specified in the job data for image formation. In the smudge reduction mode, the image forming assembly 10 reduces the overall amount of ink used in image formation from the amount used in the normal mode. The smudge reduction mode reduces the likelihood of paper contamination as follows. Paper contamination occurs when a sheet of paper becomes warped or deformed due to ink deposition and contacts the head 12. The smudge reduction mode reduces the likelihood of this phenomenon occurring by reducing the overall quantity of ink deposited on the paper. The smudge reduction setting can be set to either ON or OFF. The smudge reduction setting of ON corresponds to using the smudge reduction mode, while a smudge reduction setting of OFF corresponds to using the normal mode.

The touchscreen display 20 displays objects, such as text and images, on a screen. When the user touches the screen with a contact object such as a finger, the touchscreen display 20 detects the contact position and outputs the detection results to the controller 30. In this way, the touchscreen display 20 can accept various user input. When the user touches the screen with a contact object such as a finger while the screen displays graphical user interface (GUI) images (hereinafter referred to as “GUI images”), the controller 30 recognizes that the GUI image located at the touched position is operated. The controller 30 receives the input from the touchscreen display 20 of information associated with that operation. The touchscreen display 20 is an example of the user input interface, and an example of the output interface.

The controller 30 includes various hardware. As shown in FIG. 1, the hardware of the controller 30 includes a central processing unit (CPU) 30a; a storage (memory) 31 including a read-only memory (ROM) 30b and a random-access memory (RAM) 30c; and an application-specific integrated circuit (ASIC; not shown).

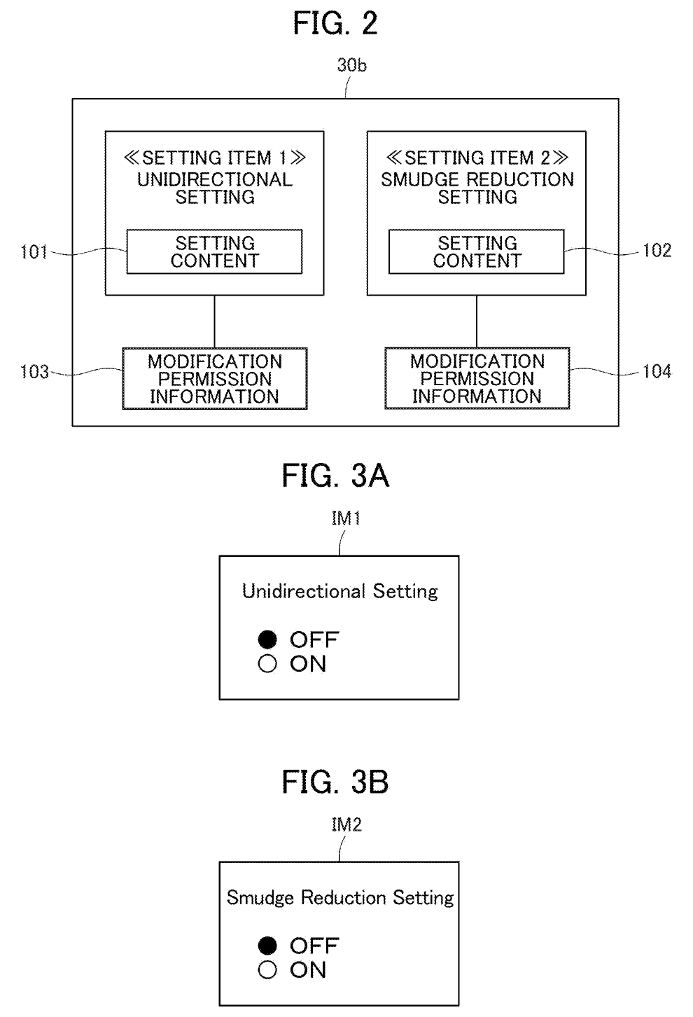

The ROM 30b includes nonvolatile memory and is used as a storage area for long-term data storage. The ROM 30b stores various data including program data for programs executed by the CPU 30a and the ASIC. A rewritable area of the ROM 30b stores values (setting contents) for settings (setting items) and information indicating whether those values can be modified (hereinafter called “modification permission information”). The setting values include values set for the unidirectional setting and the smudge reduction setting. As shown in FIG. 2, the ROM 30b stores setting content 101 for the former setting and setting content 102 for the latter setting. The modification permission information for each setting will be described later.

The RAM 30c is configured of volatile memory and functions as a temporary work storage area. Within this storage area are allocated a storage area that stores the above program data, a storage area that stores image data representing an image to be formed on paper, and a storage area that stores temporary data for other operations. Program data is transferred from the ROM 30b and stored in the storage area for programs. The storage area for image data stores image data in various formats.

Hardware of the controller 30, which includes the CPU 30a, executes various processes based on the program data and other data in the storage 31. These processes will be described below.

The controller 30 accepts user input via the GUI for the values of the two settings described above in accordance with the GUI images displayed on the screen of the touchscreen display 20. The controller 30 modifies the content of each setting according to user input instructing the content to be modified. This process to modify the contents of settings is an example of the setting modification process.

FIG. 3A shows an image IM1 displayed on the touchscreen display 20. The image IM 1 is an example of a GUI image. The image IM1 accepts an inputted value for the unidirectional setting. By touching the screen of the touchscreen display 20 with a contact object such as a finger in the area where the image IM1 is displayed, the user can toggle the unidirectional setting on and off.

FIG. 3B shows an image IM2 displayed on the touchscreen display 20. The image IMS is an example of a GUI image. The image IM2 accepts an inputted value for the smudge reduction setting. By touching the screen of the touchscreen display 20 with a contact object such as a finger in the area where the image IM2 is displayed, the user can toggle the smudge reduction setting on and off.

The controller 30 executes an image formation process by controlling the image forming assembly 10 to perform an image forming operation based on job data received from the PC 200. The job data is data with instructions for the printer 100 to form images. The job data includes image data for forming one or more images on a single page or multiple pages of paper, and the values of the unidirectional setting and the smudge reduction setting. The controller 30 executes the image formation process according to setting values specified in the job data or setting values stored in the ROM 30b. The method of determining whether to apply setting values indicated in the job data or setting values stored in the ROM 30b will be described later. The job data is an example of the print instruction.

Specifically, the controller 30 controls the carriage 11 and the head 12 to perform one of the unidirectional forming operation and the bidirectional forming operation specified by the setting content for the unidirectional setting. The process performed in which the controller 30 controls the carriage 11 and the head 12 to perform the unidirectional forming operation is an example of the unidirectional image forming process and an example of the unidirectional printing. The process performed in which the controller 30 controls the carriage 11 and the head 12 to perform the bidirectional forming operation is an example of the bidirectional image forming process and an example of the bidirectional printing.

The controller 30 processes image data according to whether the mode specified in the settings is the normal mode or the smudge reduction mode and controls the head 12 to perform an image forming operation based on the processed data. Specifically, the controller 30 performs a process to obtain the color densities for each pixel from the image data contained in the job data. The image data specifies the densities of red (R), green (G), and blue (B) for each pixel in the image. The controller 30 then executes a process to convert this image data specifying RGB densities to image data specifying densities in cyan (C), magenta (M), yellow (Y), and black (K) (hereinafter, this process will be called the “conversion process”). Next, the controller 30 obtains the color densities for each pixel from the image data specifying CMYK densities and controls the image forming assembly 10 to perform an image forming operation based on the obtained color densities. When performing the conversion process on image data, the density of each of the CMYK colors generated from the conversion process in the smudge reduction mode will be lower than the density of each of the CMYK colors generated from the conversion process in the normal mode. Specifically, for each pixel, the density of each of the CMYK colors generated from the conversion process in the smudge reduction mode will be lower than the density of each of the CMYK colors generated from the conversion process in the normal mode. Alternatively, for each pixel, the density of each of the CMYK colors generated from the conversion process in the smudge reduction mode will be lower than or equal to the density of each of the CMYK colors generated from the conversion process in the normal mode. Alternatively, for at least one pixels, the density of each of the CMYK colors generated from the conversion process in the smudge reduction mode will be lower than the density of each of the CMYK colors generated from the conversion process in the normal mode. Consequently, the overall quantity of ink deposited on sheets of paper during the smudge reduction mode is less than that in the normal mode, making smudges less likely to appear on the paper. The conversion process is an example of the specific process and an example of the processing image data. The process for obtaining color densities from the image data after the conversion process in the normal mode is an example of the first density obtaining process and an example of the density obtaining process in the first mode. The process for obtaining color densities from the image data after the conversion process in the smudge reduction mode is an example of the second density obtaining process and an example of the obtaining process in the second mode.

As shown in FIG. 1, the PC 200 includes a user input interface 40, a display 50, and a controller 60. The user input interface 40 includes a keyboard, and mouse for accepting various user input. The display 50 displays text, and images on a screen. The user operates GUI images displayed on the display 50 by performing input operations on the user input interface 40. The controller 60 then receives information corresponding to these operations.

The controller 60 includes a CPU, ROM, RAM, and other hardware. The controller 60 executes a process to generate job data according to instructions the user inputs via the user input interface 40. The PC 200 transmits the job data generated by the controller 60 to the printer 100.

When various settings related to image formation are configurable on the printer 100, as described above, it is conceivable that a user may attempt to modify these settings by operating the touchscreen display 20 during an image forming operation. In this case, when the unidirectional setting is to be modified during an image forming process, for example, the quality of the image being formed on the paper is unlikely to vary because the only difference generated between the ON and OFF unidirectional settings is whether the image is formed while the head 12 moves in both outward and return directions or whether the image is formed while the head 12 moves in only one direction. In contrast, when the value of the smudge reduction setting is modified, the quantity of ink used in the image forming operation is reduced. Therefore, if the user were to modify the smudge reduction setting during an image forming operation, the quality of the image being formed on one page of the paper may change midway, causing the formed image to appear unnatural. Thus, an undesirable situation could result from modifying this setting during an image forming operation.

As one measure to resolve this issue, the printer 100 and PC 200 according to the embodiment are configured as follows.

First, the modification permission information stored in the ROM 30b on the printer 100 has the following contents. Specifically, modification permission information 103 is associated with the unidirectional setting, and modification permission information 104 is associated with the smudge reduction setting, as illustrated in FIG. 2. Here, the modification permission information 103 specifies “modification allowed,” indicating that the setting can be changed during an image forming operation for one page (one sheet). However, the modification permission information 104 specifies “modification not allowed,” indicating that the setting cannot be modified during an image forming operation for one page (one sheet). The image forming operation for one page (one sheet) is an example of a process for printing one sheet. The unidirectional setting is an example of a setting whose modification is permitted during printing. The smudge reduction setting is an example of a setting whose modification is not permitted during printing.

The controller 60 of the PC 200 generates job data as follows. The controller 60 generates image data in accordance with user input received through the GUI based on the GUI images displayed on the screen of the display 50. Specifically, the controller 60 generates image data through one of various processes including a process to generate image data representing documents or diagrams and a process to import image data into the PC 200 from a Universal Serial Bus (USB) memory, a digital camera, or other external device.

The controller 60 also accepts user input specifying the values of the unidirectional setting and smudge reduction setting through the GUI including the GUI images displayed on the screen of the display 50. In addition to the values for the above two settings, the controller 60 of the embodiment accepts values for a device priority setting and an instant change setting.

The device priority setting indicates whether to prioritize the settings configured on the printer 100 for the unidirectional setting and the smudge reduction setting. The device priority setting can be selectively set to ON or OFF. A device priority setting of ON corresponds to prioritizing the settings configured on the device (the printer 100 in this case), i.e., applying the settings on the printer 100. A device priority setting of OFF corresponds to not prioritizing the settings on the device (the printer 100 in this case) but prioritizing the settings in the job data.

The instant change setting toggles the mode for instant changes between an instant change enabled mode and an instant change disabled mode. In the instant change enabled mode, user input to modify a setting on the printer 100 performed through the touchscreen display 20 during an image forming process instantly changes the setting when possible. In the instant change disabled mode, settings are not instantly changed during an image forming process, regardless of whether such user input was received or whether an instant change to that setting is possible (whether the modification permission information for that setting indicates “modification allowed”. The instant change setting can be selectively set to ON or OFF. An instant change setting of ON corresponds to using the instant change enabled mode, while an instant change setting of OFF corresponding to using the instant change disabled mode. The instant change setting of ON included in the job data is an example of the print instruction including the first information. The instant change setting of OFF in the job data is an example of the print instruction including the second information.

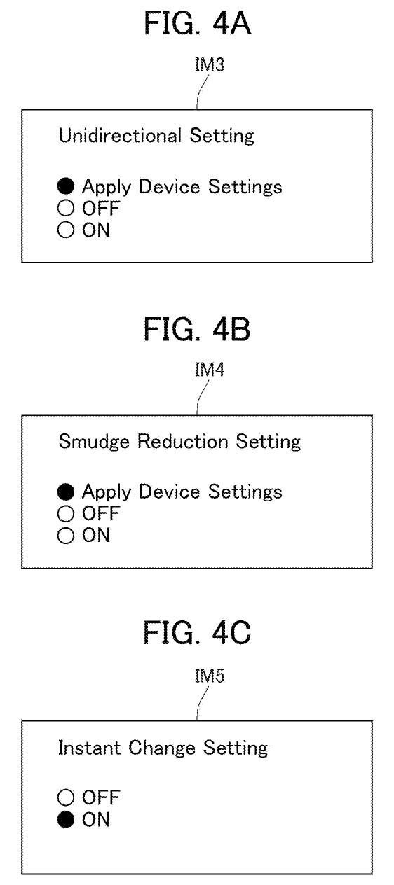

FIG. 4A shows an image IM3 displayed on the screen of the display 50. The image GM 3 is an example of a GUI image. The image IM3 accepts an inputted value for the unidirectional setting. By performing an operation through the user input interface 40 on the image IM3 displayed on the screen of the display 50, the user can set two types of settings related to the unidirectional setting, i.e., a setting of the device priority setting for the unidirectional setting, and a setting to determine whether the unidirectional setting is to be performed. Specifically, the user can toggle the device priority setting on and off for the unidirectional setting, and can toggle the unidirectional setting on and off when not applying the device settings.

Specifically, the image IM3 includes options for selecting “Apply device settings,” “OFF,” and “ON.” When “Apply device settings” is selected through the screen including the image IM3, the controller 60 generates job data specifying that the device priority setting is ON for the unidirectional setting. When “OFF” is selected through the screen, the controller 60 generates job data specifying that the device priority setting is OFF and that the unidirectional setting is OFF. When “ON” is selected through the screen, the controller 60 generates job data specifying that the device priority setting is OFF and that the unidirectional setting is ON.

FIG. 4B shows an image IM4 displayed on the screen of the display 50. The image IM4 is an example of a GUI image. The image IM4 accepts inputted values for the smudge reduction setting. By performing an operation through the user input interface 40 on the image IM3 displayed on the screen of the display 50, the user can set two types of settings related to the smudge reduction setting, i.e., a setting of the device priority setting for the smudge reduction setting, and a setting to determine whether the smudge reduction is to be performed. Specifically, the user can toggle the device priority setting on and off for the smudge reduction setting, and can toggle the smudge reduction setting on and off when not applying the device settings.

Specifically, the image IM4 has the selectable options “Apply device settings,” “OFF,” and “ON.” When “Apply device settings” is selected through the screen including the image IM4, the controller 60 generates job data specifying that the device priority setting is ON. When “OFF” is selected through the screen, the controller 60 generates job data specifying that the device priority setting is OFF and the smudge reduction setting is OFF. When “ON” is selected through the screen, the controller 60 generates job data specifying that the device priority setting is OFF and the smudge reduction setting is ON.

FIG. 4C shows an image IM5 displayed on the screen of the display 50. The image IM5 is an example of a GUI image. The image IM5 accepts inputted values for the instant change setting. By performing an operation through the user input interface 40 on the image IM5 displayed on the screen of the display 50, the user can toggle the instant change setting. Specifically, the image IM5 has the selectable options “OFF” and “ON.” When “OFF” is selected through the screen including the image IM5, the controller 60 generates job data specifying that the instant change setting is OFF. When “ON” is selected through the screen, the controller 60 generates job data specifying that the instant change setting is ON.

The controller 60 transmits job data containing image data and data specifying the settings acquired as described above to the printer 100.

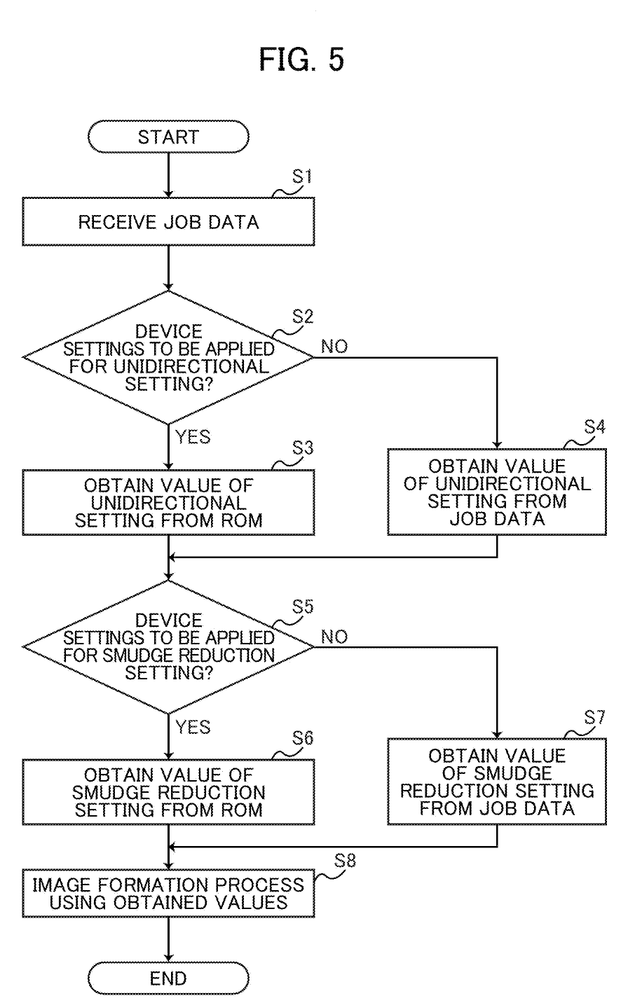

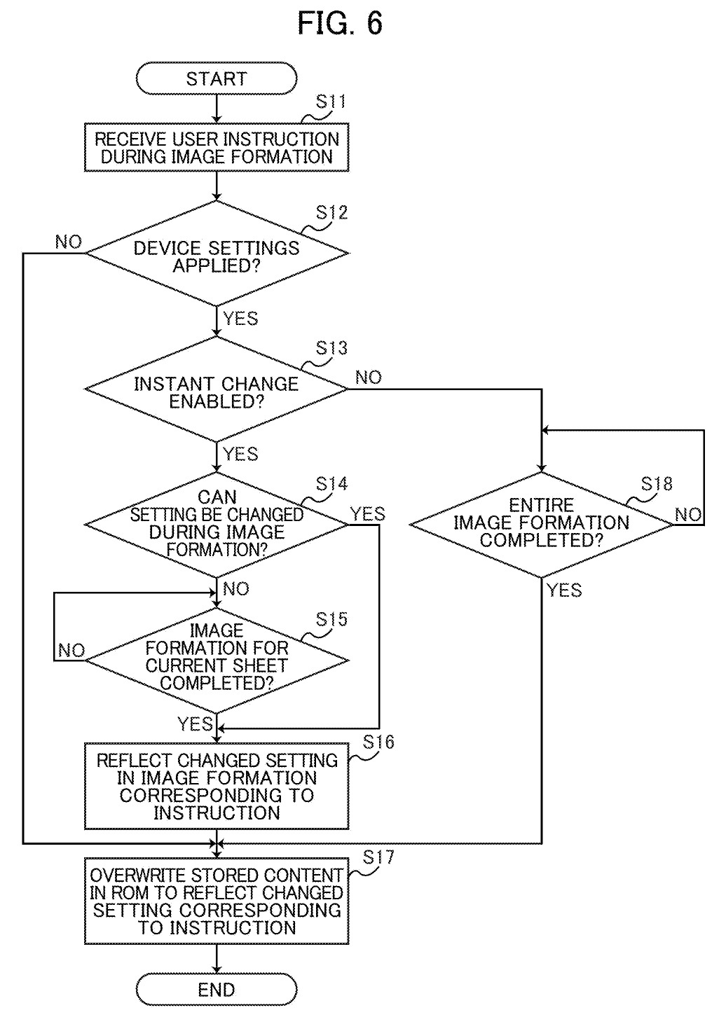

Next, a sample process performed on the printer 100 will be described with reference to FIGS. 5 and 6. The controller 30 of the printer 100 performs this process upon receiving job data from the PC 200. In this example, the job data is data for performing an image forming operation on a plurality of sheets of paper. In S1 of FIG. 5, the controller 30 receives the job data from the PC 200. In S2 the controller 30 determines whether the value of the device priority setting specified in the job data indicates that the unidirectional setting is ON, i.e., that the device settings are to be applied for the unidirectional setting. When the controller 30 determines that the device settings are to be applied for the unidirectional setting (S2: YES), in S3 the controller 30 obtains the value of the unidirectional setting from the ROM 30b. On the other hand, when the controller 30 determines that the device settings are not to be applied to the unidirectional setting (S2: NO), in S4 the controller 30 obtains the value for the unidirectional setting from the job data.

In S5 the controller 30 determines whether the value of the device priority setting specified in the job data indicates that the smudge reduction setting is ON, i.e., that the device settings are to be applied to the smudge reduction setting. When the controller 30 determines that the device settings are to be applied to the smudge reduction setting (S5: YES), in S6 the controller 30 obtains the value of the smudge reduction setting from the ROM 30b. On the other hand, when the controller 30 determines that the device settings are not to be applied to the smudge reduction setting (S5: NO), in S7 the controller 30 obtains the value of the smudge reduction setting from the job data.

In S8 the controller 30 executes an image formation process based on the setting values obtained in S3 or S4 and in S6 or S7. The image formation process for printing all images for sheets designated in the print job received in S1 is an example of the image forming process or the printing process.

In some cases, the user might operate the touchscreen display 20 while the image formation process in S8 of FIG. 5 is being executed and attempt to change the value of the unidirectional setting or the smudge reduction setting. The process performed by the controller 30 in such cases will be described with reference to FIG. 6. In S11 of FIG. 6, the controller 30 receives a user instruction to modify a setting as input through the touchscreen display 20. In S12 the controller 30 references the device priority setting in the job data for a target setting item to be subjected to the change received in S11 and determines whether the device settings are applied for the target setting item. For example, the target setting item is a setting item indicating the unidirectional setting or smudge reduction setting. When the controller 30 determines that the device settings are not applied for the target setting item (S12: NO), the controller 30 advances to the process of S17 described later. The user instruction to modify a setting is an example of a modification instruction.

However, when the controller 30 determines in S12 that the device settings are for the target setting item (S12: YES), in S13 the controller 30 references the instant change setting in the job data and determines whether an instant change to the setting is enabled. When the controller 30 determines that the instant change is not enabled (S13: NO), in S18 the controller 30 waits until the entire image formation process based on the job data (the image formation process for all the sheets designated in the job data) is completed, i.e., all of the plurality of images (pages) designated in the job data is printed on the plurality of sheets (S18: NO). When the entire image formation process is completed (S18: YES), the controller 30 advances to the process of S17 described later.

However, when the controller 30 determines in S13 that the instant change is enabled (S13: YES), in S14 the controller 30 references the modification permission information in the ROM 30b for the target setting item specified in the instruction received in S11 and determines whether the setting for the target setting item can be changed during an image forming operation on one page. When the controller 30 determines that the modification permission information indicates changes are allowed, i.e., when the setting in question can be changed during an image forming operation for one page (S14: YES), the controller 30 advances to S16 described later. However, when the controller 30 determines that the modification permission information indicates that changes are not allowed, i.e., when the setting in question cannot be changed during an image forming operation on one page (S14: NO), in S15 the controller 30 waits until the image forming operation for the current page is completed (S15: NO) and advances to S16 once the image forming operation for the current page is completed (S15: YES).

In S16 the controller 30 reflects the changed setting in the image formation process according to the input received in S11. Thus, when the controller 30 executes the process of S16 following S15, the controller 30 reflects the changed setting after completing the image forming operation for the current page and prior to beginning the image forming operation for the next page. However, when the process advances to S16 directly from S14, without executing the process of S15, the controller 30 reflects the changed setting while the image forming operation is being executed for the current page.

As an example, when the input received in S11 is an instruction to toggle the value of the unidirectional setting from ON to OFF, the controller 30 changes the method of the image formation process from one using unidirectional forming operations to one using bidirectional forming operations without going through the process of S15. As another example, when the input received in S11 is an instruction to change the value of the smudge reduction setting from OFF to ON, the controller 30 changes the method of the image formation process from one using the normal mode to one using the smudge reduction mode after the process of S15 has been performed.

In S17 the controller 30 overwrites the stored content in the ROM 30b to reflect the changed setting corresponding to the input received in S11. In other words, the controller 30 modifies the setting stored in the ROM 30b based on the user instruction received in S11. When a YES determination is made in S14 and the process proceeds to S17, the process of S17 may be performed while the image forming operation is being executed for the current page. That is, execution of the process of S17 is permitted during execution of the image forming operation (printing process). This ends the process of FIG. 6.

According to the embodiment described above, the modification permission information stored in the ROM 30b indicates for each setting (i.e., for each of the unidirectional setting and the smudge reduction setting) whether the value of the setting can be changed during an image forming operation on one page. When an instruction to modify a setting is inputted via the touchscreen display 20 during an image formation process, the value of the setting is immediately changed when the corresponding modification permission information for that setting indicates that the setting can be changed during an image forming operation for one page. Thus, the changed setting specified by the modification instruction is reflected in the image forming operation currently being executed. On the other hand, the value of a setting is not immediately changed when the corresponding modification permission information for that setting indicates that the setting cannot be modified during the image forming operation for one page (one sheet). Thus, the changed setting based on the modification instruction is not immediately reflected in the image forming operation being executed but is reflected in the image forming operation for the next page after the image forming operation is completed for the current page. This method makes it possible to modify settings quickly when possible while reducing the occurrence of undesirable situations such as the quality of an image being changed during an image forming operation for one page. Accordingly, this method can realize a device capable of responding appropriately to situations in which changes are about to occur to settings during image formation.

In the above embodiment, the controller 30 determines whether the device settings are to be applied, i.e., whether settings are to be based on values stored in the ROM 30b of the printer 100 or based on the job data, in accordance with the device priority setting in the job data. Therefore, information received from an external device (the PC200 in this example) can be used appropriately to select whether the setting values configured on the printer 100 side are to be used.

In the present embodiment, the unidirectional setting, whether ON or OFF, has no great effect on the quality of images formed on paper. Therefore, changing this setting during an image forming operation is not a significant problem. However, changes to settings that can vary the color densities of pixels, such as the smudge reduction setting, could significantly impact the quality of images formed on the medium. Consequently, modifying the values of such settings during an image forming operation for one page could cause an issue with the quality of images formed on the paper. Accordingly, by configuring the modification permission information to indicate that changes are allowed for settings related to the unidirectional setting but are not allowed for settings related to the smudge reduction setting, this configuration allows settings to be quickly modified without greatly impacting image quality.

In the above embodiment, the controller 30 converts image data specifying RGB densities into image density specifying CMYK densities. The color densities for each pixel specified by the image data resulting from this conversion process differ between the normal mode and the smudge reduction mode. Thus, changes to settings related to the smudge reduction setting results in differences in the content of image data generated by the conversion process. This also results in differences in the quality of images formed on paper based on the converted image data. On the other hand, changes in values related to the unidirectional setting do not result in different content in image data generated by the conversion process and therefore are unlikely to generate differences in the quality of images formed on paper based on the converted image data. Accordingly, the modification permission information is configured to indicate that values cannot be changed for settings that cause differences in the content of image data generated from the conversion process and that values can be changed for settings that do not cause differences in the content of image data generated from the conversion process. This achieves a configuration that can quickly change settings without significantly affecting image quality. Changes to settings related to the smudge reduction setting may result in differences in the image data generated by the conversion process. Changes in values related to the unidirectional setting may not result in different the image data generated by the conversion process.

By switching the instant change setting ON and OFF in the job data, the controller 30 in the above embodiment can toggle the permission mode for instant changes between an instant change enabled mode in which settings can be quickly changed when possible and an instant change disabled mode in which settings cannot be changed immediately. When the value of the instant change setting is OFF in the job data, the controller 30 of the printer 100 may display, during an image forming operation, a message on the touchscreen display 20 indicating that the value of the unidirectional setting and smudge reduction setting cannot be modified during the image forming operation. As a specific example, both images IM1 and IM2 shown in FIGS. 3A and 3B may be grayed out during the image formation process so that the user cannot access their GUI images. This suitably indicates to the user that changes in settings are not accepted during the image formation process.

As described above, the values of settings for which the modification permission information indicates that changes are allowed (i.e., the unidirectional setting) can be changed immediately, even during an image forming operation for one page (one sheet). However, the values of settings for which the modification permission information indicates that changes are not allowed (i.e., the smudge reduction setting) are not changed until after the image forming operation for the current page is completed. This can achieve a configuration capable of quickly changing settings when possible while reducing the chance of generating changes in image quality within a single page of paper.

The following configuration may be employed as an alternative. The values of settings for which the modification permission information indicates that changes are allowed (e.g., the unidirectional setting) are changed immediately, even during an image forming operation for a single page. However, the values of settings for which the modification permission information indicates that changes are not allowed (e.g., the smudge reduction setting) are not changed until image forming operations for all pages (all sheets) including the image forming operation for the current page (current sheet) are completed. Such a method can achieve a configuration capable of quickly modifying settings when possible while reducing the chance of a change in image quality occurring among the plurality of pages. The series of image forming operations for all pages is an example of the image forming process (or the printing process) for the plurality of sheets.

The image forming operations for the above plurality of pages (sheets) may be one image forming operation for all data in a single job. This configuration reduces the risk of the image quality changing during the image forming operation for one complete job. One example of a setting whose value is better left unchanged during an image forming operation for one entire job might be a setting for enlarging or reducing the size of the images being formed on paper. In this case, it would be appropriate not to change whether the images are enlarged or reduced or to change the enlargement or reduction ratio during the image forming operation for the overall job.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are described below:

The sample process described with reference to FIG. 6 in the above embodiment assumes that the printer 100 receives job data for forming images on a plurality of pages of paper. However, the same process described in FIG. 6 may be performed when the printer 100 receives job data for forming an image on a single page of paper. In this case, when the user inputs an instruction to change the value of a setting for which the modification permission information indicates that changes are not allowed (e.g., the smudge reduction setting) during the image forming operation for the single page, the controller 30 modifies the setting in accordance with the user-inputted value after completing the image forming operation for the single page, i.e., after the image forming operation for the entire job data has been completed.

While the disclosure has been made with reference to an example involving the printer, the invention is not limited to such an example. For example, the invention may be applied to other inkjet-type image forming devices that eject ink from a head, such as a multifunction peripheral, a copy machine, or the image forming devices of these machines. Alternatively, the invention may be applied to a laser-type image forming device that performs image recording processes by depositing toner on printing paper. In this case, toner cartridges accommodating toner are removably mounted in the image forming device.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

The term “processor” encompasses both a single processor or a group of multiple processors located either locally or remotely working together or in a distributed fashion to collectively perform the tasks attributed to the “processor” described herein. One or more processors may be referred to as a controller.

What is claimed is:

1. An image forming device comprising:
a printing engine;
a user interface;
a storage; and
a controller including one or more processors, the controller being configured to perform:
a printing process including:
printing one or more images on one or more sheets using the printing engine based on a print instruction; and
a setting modification process in response to receiving, under a modification condition, a modification instruction through the user interface during the printing process, the modification instruction being an instruction to modify a target setting, the target setting being a setting of one or more settings stored in the storage, the modification condition including a requirement that setting permission information stored in the storage indicates that modification of the target setting is permitted during printing, the setting modification process including:
modifying the target setting stored in the storage based on the modification instruction,
wherein, even when the controller receives the modification instruction through the user interface during printing on one sheet of the one or more sheets, the setting modification process is not performed at least during printing on the one sheet under a disable condition including a requirement that the setting permission information indicates that modification of the target setting is not permitted during printing.

2. The image forming device according to claim 1,
wherein the modification condition further includes a requirement that the print instruction includes first information,
wherein in a case where the print instruction includes second information different from the first information, the setting modification process is not performed even when the controller receives the modification instruction through the user interface during the printing process.

3. The image forming device according to claim 1,
wherein the printing engine includes a head configured to reciprocate in forward and backward directions,
wherein the one or more settings include a first setting and a second setting,
wherein the first setting specifies either a bidirectional printing or a unidirectional printing,
wherein the second setting specifies either a first mode or a second mode,
wherein when the first setting stored in the storage specifies the bidirectional printing, the printing process is performed in a bidirectional mode, whereas when the first setting stored in the storage specifies the unidirectional printing, the printing process is performed in a unidirectional mode,
wherein in the printing process in the bidirectional mode, the head forms an image on a sheet during movement of the head in the forward and backward directions,
wherein in the printing process in the unidirectional mode, the head forms an image on a sheet during movement of the head in the forward direction but does not form any image on the sheet during movement of the head in the backward direction,
wherein the setting permission information includes first setting permission information indicating that modification of the first setting is permitted during printing,
wherein the controller is configured to further perform:
a density obtaining process including:
obtaining a target color density of a pixel from image data,
wherein the printing process is performed based on the target color density,
wherein when the second setting stored in the storage specifies the first mode, the density obtaining process is performed in the first mode, whereas when the second setting stored in the storage specifies the second mode, the density obtaining process is performed in the second mode,
wherein in the density obtaining process in the first mode, a first color density is obtained as the target color density,
wherein in the density obtaining process in the second mode, a second color density is obtained as the target color density, the second color density being lower than the first color density,
wherein the setting permission information includes second setting permission information indicating that modification of the second setting is not permitted during printing.

4. The image forming device according to claim 1,
wherein the printing process further include:
processing image data,
wherein the printing process is performed based on the processed image data,
wherein the one or more settings includes a first type setting and a second type setting,
wherein modification of the first type setting does not influence the processing in a way that affects content of the processed image data, whereas modification of the second type setting influences the processing in a way that affects the content of the processed image data,
wherein the setting permission information indicates that the modification of the first type setting is permitted during printing, whereas the setting permission information indicates that the modification of the second type setting is not permitted during printing.

5. The image forming device according to claim 1,
wherein the controller is configured to operate either in an enable mode or in a disable mode,
wherein when the controller operates in the enable mode, the setting modification process is enabled, whereas when the controller operates in the disable mode, the setting modification process is disabled even when the modification instruction is received through the user interface during the printing process.

6. The image forming device according to claim 5,
wherein when the controller operates in the disable mode, the controller outputs, during the printing process, information indicating that the modification instruction cannot be accepted.

7. The image forming device according to claim 1,
wherein the modification condition further includes: a requirement that the modification instruction is received through the user interface during printing on the one sheet of the one or more sheets; and a requirement that the setting permission information indicates that the modification of the target setting is permitted during printing on the one sheet,
wherein the disable condition further includes a requirement that the setting permission information indicates that the modification of the target setting is not permitted during printing on the one sheet,
wherein the controller is configured to further performs:
the setting modification process in response to receiving, under a second modification condition, the modification instruction through the user interface during printing on the one sheet, the second modification condition including: a requirement that the disable condition is met; and a requirement that printing on the one sheet is completed.

8. The image forming device according to claim 1,
wherein the modification condition further includes: a requirement that the one or more sheets includes a plurality of sheets; and a requirement that the setting permission information indicates that the modification of the target setting is permitted during printing on the plurality of sheets,
wherein the disable condition further includes: a requirement that the one or more sheets includes the plurality of sheets; and a requirement that the setting permission information indicates that the modification of the target setting is not permitted during printing on the plurality of sheets,
wherein the controller is configured to further performs:
the setting modification process in response to receiving, under a second modification condition, the modification instruction through the user interface during the printing process, the second modification condition including a requirement that the disable condition is met; and a requirement that printing on the plurality of sheets is completed.

9. The image forming device according to claim 1,
wherein execution of the setting modification process is permitted during execution of the printing process.
